(19) United States
(12) Patent Application Publication
(10) Pub. No.: US 2019/0337241 A1
(43) Pub. Date: Nov. 7, 2019

(54) METHOD FOR MANUFACTURING MOLDED SLIME COMPOUNDS

(71) Applicant: Horizon Group USA, Inc., Warren, NJ (US)

(72) Inventors: Wendy MASTAL, Kearny, NJ (US); Alexie ARENA, New Hope, PA (US); Allison CARGILL, Hoboken, NJ (US); Emmanuel R. VALDEZ, JR., Dunellen, NJ (US)

(21) Appl. No.: 16/047,996

(22) Filed: Jul. 27, 2018

Related U.S. Application Data
(63) Continuation of application No. 15/970,642, filed on May 3, 2018.

(51) Int. Cl. B29C 67/24; B29C 33/42

(52) U.S. Cl. CPC B29C 67/24; B29C 33/424; B29K 2005/00

(57) ABSTRACT

Embodiments disclosed herein provide for an improved method of manufacturing molded slime compounds. Embodiments provide for a mold device including a mold bottom and a handle, wherein the mold bottom forms a shape of the molded slime compound. Embodiments further provide for forming the molded slime compound based on an interaction between a base solution including an algin-based compound and an activator solution including a calcium-based compound.

### CROSS-REFERENCE TO RELATED APPLICATION

This application relates to and claims priority from U.S. patent application Ser. No. 15/970,642, filed on May 3, 2018, the entire disclosure of which is incorporated herein by reference.

### TECHNICAL FIELD

The present application relates to an improved method of manufacturing molded slime compounds.

### BACKGROUND

Slime compounds are preferred by many children due to the unique tactile experience they provide. For example, the slime compounds can, at times, act like a solid and, at other times, act like a liquid. Slime compounds are non-Newtonian fluids that include polymers which allow the slime compound to transition from a liquid-like to a solid-like state. Specifically, when a certain force (e.g., stirring, tearing, etc.) is applied to the slime compound, the polymers in the slime compound entangle, thereby causing the slime compound to enter a solid-like state, e.g., a polymer solid. Otherwise, if the slime compound is left alone or if only a slight force is applied to it, the polymers in the slime compound remain curled up and, therefore, the slime compound may act more like a liquid. In addition to the unique tactile experience, the slime compounds may also come in a variety of different colors and, therefore, may be very visually stimulating. For these reasons and many others, children have found slime compounds to be both fun and educational.

However, slime compounds are also known for being quite messy. This is particularly true for creating more solid-like shapes with the slime compound, e.g., spheres, donuts, stars, etc.

Accordingly, there is a need for an improved, mess-free, method of manufacturing molded slime compounds.

### BRIEF DESCRIPTION OF THE DRAWINGS

FIG. 1 illustrates an example embodiment of a mold device to form the molded slime compounds.

FIG. 2 illustrates other embodiments of the mold device depicted in FIG. 1.

### DESCRIPTION OF EMBODIMENTS

The following description of embodiments provides non-limiting representative examples referencing numerals to particularly describe features and teachings of different aspects of the invention. The embodiments described should be recognized as capable of implementation separately, or in combination, with other embodiments from the description of the embodiments. A person of ordinary skill in the art reviewing the description of embodiments should be able to learn and understand the different described aspects of the invention. The description of embodiments should facilitate understanding of the invention to such an extent that other implementations, not specifically covered but within the knowledge of a person of skill in the art having read the description of embodiments, would be understood to be consistent with an application of the invention.

One aspect of the present disclosure is to provide an improved method of manufacturing molded slime compounds. The methods herein address at least one of the problems discussed above.

According to an embodiment, a method for manufacturing a molded slime compound includes: adding at least one base solution to a mold device, wherein the mold device includes a mold bottom; submerging the mold device with the added at least one base solution into an activator solution; agitating the submerged mold device with the added at least one base solution in the activator solution, wherein the agitating causes an interaction between the base solution and the activator solution; and forming the molded slime compound based on the interaction between the base solution and the activator solution, wherein the molded compound corresponds to a shape of the mold bottom.

According to an embodiment, a mold device for manufacturing a molded slime compound includes: a mold bottom; and a handle, wherein: the mold bottom forms a shape of the molded slime compound, and the handle extends radially and outwardly in an upwards direction from an upper surface of the mold bottom.

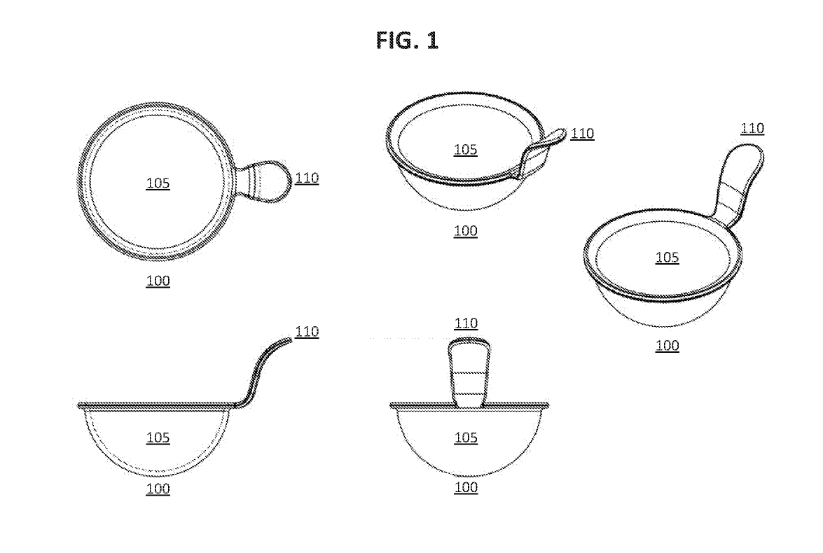

FIG. 1 illustrates an example embodiment of a mold device to form the molded slime compounds. In particular, FIG. 1 illustrates multiple views of a mold device 100. In an embodiment, the mold device 100 includes a mold bottom 105 and a handle 110. In an embodiment, the mold bottom 105 may be a hemispherical shape. In an embodiment, the mold bottom 105 includes a hollow inside. In an embodiment, the hollow inside of the mold bottom 105 may be utilized to hold and mold a slime compound. Specifically, the mold bottom 105 may be utilized to mold a spherical slime compound. Further, in an embodiment, the handle 110 extends radially and outwardly in an upwards direction from an upper surface of the mold bottom 105. In an embodiment, the bottom of the handle 110 extends from the upper surface of the mold bottom 105. In an embodiment, a portion of the handle 110 may form a concave-like profile. Further, in an embodiment, the shape and position of the handle 110 facilitates a cleaner experience for manufacturing the molded slime compounds. Specifically, with the handle 110, the mold device 100 is able interact with a plurality of solutions without dipping or submerging a user's hands into the solutions. In an embodiment, the mold bottom 105 and the handle 110 may be integrally connected.

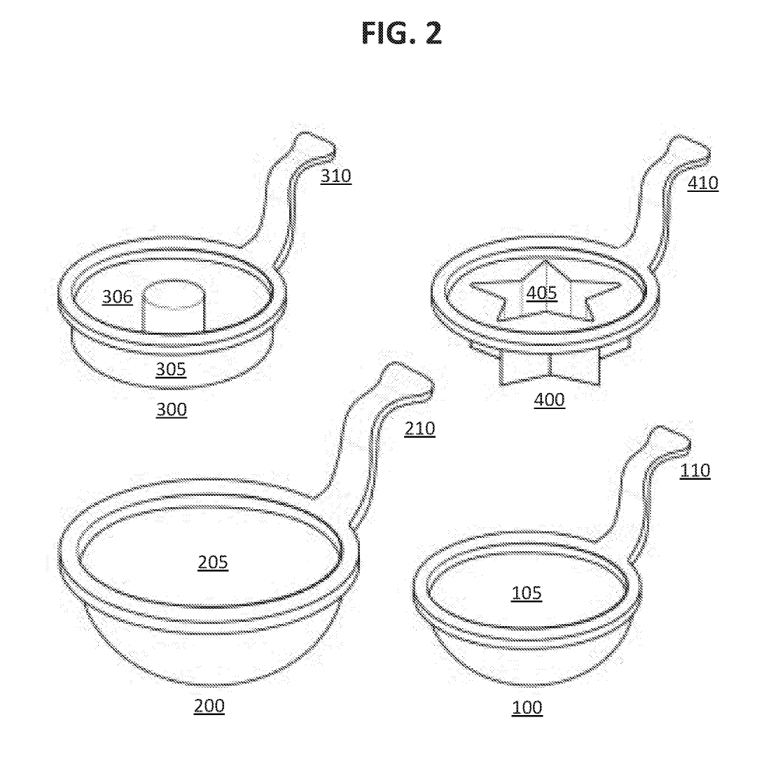

FIG. 2 illustrates other embodiments of the mold device depicted in FIG. 1. As depicted in the figure, in addition to the mold device 100, FIG. 2 also includes mold devices 200, 300, and 400. In an embodiment, the mold device 200, which includes a mold bottom 200 and a handle 210, is similar to the mold device 100 except that the mold device 200 is larger in size and, therefore, can form a larger molded slime compound. Similarly, the mold device 300 also includes a mold bottom 305 and a handle 310. However, unlike the mold devices 100 and 200, the mold bottom includes a cylinder portion 306 extending from a flat lower surface. In an embodiment, an upper surface of the cylinder portion 306 does not extend beyond an upper surface of the mold bottom 305. In an embodiment, the mold device 300 may be utilized to mold a donut-shaped slime compound. In an embodiment, the mold device 400 also includes a mold bottom 405 and a handle 410. In an embodiment, the mold bottom 405 may include a hollow, star-shaped prism extending downwards toward a lower surface of the mold bottom 405. In an embodiment, the mold device 400 may be utilized to mold a star-shaped slime compound.

In an embodiment, the slime compound may be comprised of an algin-based compound and a calcium-based compound. In an embodiment, the algin-based compound may be derived from various aquatic plants, e.g., brown algae. In an embodiment, the algin-based compound may be sodium alginate. Further, in an embodiment, the calcium-based compound may be calcium chloride. However, in another embodiment, the calcium-based compound may be calcium lactate.

In an embodiment, each of the algin-based compound and the calcium-based compound may be prepared separately. For example, the algin-based compound may be prepared in a base solution and the calcium-based compound may be prepared in an activator solution.

In an embodiment, the base solution may be formed by first adding the algin-based compound to a bowl of warm water. For example, in an embodiment, one tablespoon (e.g., seven grams) of the algin-based compound may be added to eight ounces of warm water. Further, to help the algin-based compound to blend in with the water, the algin-based compound may be continuously whisked. Further, in an embodiment, the blending may be further improved by sprinkling and whisking the algin-based compound a little bit at a time. In an embodiment, after the algin-based compound is blended into the water, the base solution should be left to sit for a period of time, e.g., an hour or so. In addition, to further help the dissolving of the base solution, the base solution should be mixed at specific intervals while it's left to sit. For example, the base solution may be mixed every fifteen minutes or so. In an embodiment, the base solution should have a syrup-like consistency when it's ready. Further, once ready, the base solution may be provided into a plurality of different cups. Further, in an embodiment, a separate paint color may be added and mixed in to the base solution in each of the cups.

In an embodiment, the activator solution may be formed by adding and mixing in the calcium-based compound into a bowl of warm water. For example, one tablespoon (e.g., seven grams) may be added to three cups of warm water. In an embodiment, the calcium-based solution should be mixed until it is completely dissolved into the water.

In an embodiment, after the base solution and the activator solution are ready, the molded slime compounds may be prepared as follows. In a first step, one of the mold devices 100, 200, 300, and 400 is coated with the activator solution. The mold device may be coated with the activator solution by temporarily dipping the mold device into the activator solution. In an embodiment, after the mold device is sufficiently coated, any residual activator solution in the mold device may be poured back into the bowl including the activator solution. In an embodiment, the coating may facilitate the release of the later-formed molded slime compounds. Then, in a second step, at least one of the plurality different-colored base solutions may be added to the mold device. In an embodiment, the plurality of different-colored base solutions may be mixed together to create a swirl-like effect. Further, in an embodiment, glitter may also be sprinkled into the device mold between any color layer. In an embodiment, the base solution in the mold device should be at least 3-5 mm from the upper surface of the mold bottom (e.g., 105, 205, 305, or 405) of the mold device. Then, in a third step, once filled, the mold device may be dipped into the activator solution, thereby allowing the activator solution to coat the top surface of the base solution. Then, in a fourth step, after a few seconds (e.g., two to five seconds), the mold device may be submerged into the activator solution. In an embodiment, while the mold device is submerged, the mold device should be agitated (e.g., swirled) in order to have the base solution and activator solution interact to form the molded slime compound. In an embodiment, the algin-based compound of the base solution solidifies in contact with the calcium-based compound of the activator solution. Specifically, a membrane forms between the algin-based compound and the calcium-based compound. In an embodiment, the thickness of the membrane increases proportionately with the time in contact with the calcium-based compound. In an embodiment, as the molded slime compound is being formed in the activator solution, it will gradually release itself from the mold device. Then, in a fifth step, once the molded slime compound has formed, it may be poured into the activator solution from the mold device. Then, after ten to fifteen seconds, the molded slime compound may be removed from the activator solution. Specifically, in an embodiment, the molded slime compound may be retrieved before it turns into a complete solid. Further, in an embodiment, additional smaller molded slime compounds may be formed from the molded slime compound by popping the molded slime compound into the activator solution.

Further, as mentioned above, the molded slime compound may take the shape of mold bottom of the particular mold device being utilized. For example, if the mold device 105 or the mold device 205 are utilized, the molded slime compound would have a spherical shape. On the other hand, if the mold device 305 is utilized, then the molded slime compound would have a donut-like shape. Further, if the mold device 405 is utilized, then the molded slime compound would have a star-like shape.

In the foregoing Description of Embodiments, various features may be grouped together in a single embodiment for purposes of streamlining the disclosure. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Description of Embodiments, with each claim standing on its own as a separate embodiment of the invention.

Moreover, it will be apparent to those skilled in the art from consideration of the specification and practice of the present disclosure that various modifications and variations can be made to the disclosed systems without departing from the scope of the disclosure, as claimed. Thus, it is intended that the specification and examples be considered as exemplary only, with a true scope of the present disclosure being indicated by the following claims and their equivalents.

1. A method for manufacturing a molded slime compound, the method comprising:
adding at least one base solution to a mold device, wherein the mold device includes a mold bottom;
submerging the mold device with the added at least one base solution into an activator solution;
agitating the submerged mold device with the added at least one base solution in the activator solution, wherein the agitating causes an interaction between the base solution and the activator solution; and
forming the molded slime compound based on the interaction between the base solution and the activator solution, wherein the molded compound corresponds to a shape of the mold bottom.

2. The method of claim 1, wherein the at least one base solution includes an algin-based compound.

3. The method of claim 2, wherein the algin-based compound includes water and sodium alginate.

4. The method of claim 1, wherein the activator solution includes a calcium-based compound.

5. The method of claim 4, wherein the calcium-based compound includes water and one of calcium chloride and calcium lactate.

6. The method of claim 1, wherein the mold bottom is a hemispherical shape.

7. The method of claim 7, wherein the molded slime compound is a spherical shape.

8. The method of claim 1, wherein the mold bottom includes a cylindrical portion extending from a lower surface of the mold bottom.

9. The method of claim 8, wherein the molded slime compound is a donut shape.

10. The method of claim 1, wherein the mold bottom includes a star-shaped prism extending downwards toward a lower surface of the mold bottom.

11. The method of claim 10, wherein the molded slime compound is a star shape.

12. The method of claim 1, wherein each of the at least one base solution is associated with a different color.

13. The method of claim 1, further comprising:
prior to adding the at least one base solution to the mold device, dipping the mold device in the activator solution, wherein the dipping coats the mold device with the activator solution.

14. The method of claim 1, further comprising:
prior to submerging the mold device with the added at least one base solution into an activator solution, dipping the mold device with the added at least one base solution in the activator solution, wherein the dipping coats a top surface of the at least one base solution with the activator solution.

15. A mold device for manufacturing a molded slime compound, the mold device comprising:
a mold bottom; and
a handle, wherein:
the mold bottom forms a shape of the molded slime compound and includes one of (i) a cylindrical portion extending from a lower surface of the mold bottom and (ii) a star-shaped prism extending downwards toward the lower surface of the mold bottom, wherein the lower surface is solid, and
the handle extends radially and outwardly in an upwards direction from an upper surface of the mold bottom.

16. The mold device of claim 15, wherein a portion of the handle forms a concave-like profile.

17. The mold device of claim 15, wherein the mold bottom and the handle are integrally connected.

18. The mold device of claim 15, wherein the mold bottom includes a hollow inside.

19. (canceled)
